(19) United States
(12) Patent Application Publication
(10) Pub. No.: US 2024/0224935 A1
(43) Pub. Date: Jul. 11, 2024

(54) Vacuum Feeder

(71) Applicant: SHENZHEN UAH TECHNOLOGY CO., LTD, Shenzhen (CN)

(72) Inventors: Shengbo LU, Shenzhen (CN); Qiang GENG, Shenzhen (CN); Weixin LUO, Shenzhen (CN); Cong WANG, Shenzhen (CN); Yingying QIU, Shenzhen (CN)

(73) Assignee: SHENZHEN UAH TECHNOLOGY CO., LTD, Shenzhen (CN)

(21) Appl. No.: 18/176,634

(22) Filed: Mar. 1, 2023

(30) Foreign Application Priority Data
Jan. 6, 2023 (CN) 202320043095.X

(51) Int. Cl. A01K 5/01

(52) U.S. Cl. CPC A01K 5/0114

(57) ABSTRACT

A vacuum feeder includes a vacuuming part, a grain discharging hose, a sealing assembly, a grain delivery assembly, and an outer cylinder provided with a grain storage space and an installation space. The vacuuming part is used to extract the grain storage space into a vacuum state; an inlet of the grain discharging hose communicates with the grain storage space;

and the grain delivery assembly is used to delivery grain in the grain storage space into the grain discharging hose. The sealing assembly includes a sealing driving part, a blocking block, and a sealing inclined plate installed on the blocking block. An output end of the sealing driving part is connected to the blocking block, and the blocking block is used to compress and seal the grain discharging hose, and the sealing inclined plate is used to block an outlet of the grain discharging hose.

### CROSS-REFERENCE TO RELATED APPLICATIONS

The present application claims priority to Chinese Patent Application No. 202320043095.X, filed on Jan. 6, 2023, the content of which is incorporated herein by reference in its entirety.

### TECHNICAL FIELD

The present application belongs to the technical field of pet feeders, in particular, is directed to a vacuum feeder.

### BACKGROUND

With the development of social economy and the acceleration of urbanization, more and more people only live in their own small circles, and these people have less and less interpersonal communication. Pets such as cats and dogs may serve as friendly life partners for people, and these pets can not only help people relieve the loneliness of life, but also regulate people's mental health. In addition, for some elderly people who live alone, pets are also their life partners. Keeping pets is beneficial to the physical and mental health of the elderly, and through communication with pets, the life of the elderly is enriched and fulfilled.

In the process of raising pets, pets need to eat from time to time. However, in daily life, because most of the office workers are unable to take care of the three meals of pets at home, or people are unable to take care of the pet's daily diet at home because of special occasions such as business trips and travel. At this time, the smart feeder came into being, and people can remotely control the smart feeder to pour out the food, and the poured food can be eaten by pets.

In order to avoid accidents of bacterial infection of the food in the smart feeder, vacuuming parts are also installed in the smart feeder, and the storage space in the smart feeder is extracted into a vacuum state by using the vacuuming parts. However, the existing smart feeder is usually driven by a linear motor to move the panel or plug to seal the grain outlet. This smart feeder has the technical problem of poor sealing effect.

### SUMMARY

The present application provides a vacuum feeder aiming at the technical problem of poor sealing effect of the smart feeder in the prior art.

In view of the above technical problems, the embodiment of the present application provides a vacuum feeder, including a vacuuming part, a grain discharging hose, a sealing assembly, a grain delivery assembly, an outer cylinder provided with a grain storage space and an installation space. The vacuuming part is used to extract the grain storage space into a vacuum state; an inlet of the grain discharging hose communicates with the grain storage space; the grain delivery assembly is installed in the grain storage space, and is used to deliver grain in the grain storage space into the grain discharging hose; and the sealing assembly comprises: a sealing driving part, a blocking block, a sealing inclined plate installed on the blocking block, and an output end of the sealing driving part is connected to the blocking block, and the blocking block is used to compress and seal the grain discharging hose, and the sealing inclined plate is used to block an outlet of the grain discharging hose.

Optionally, the sealing driving part includes an installation seat, a rotating motor, a gear and a rack, the installation seat is installed in the installation space, the rotating motor is installed on the installation seat, the gear is sleeved on an output shaft of the rotating motor, and the rack is connected to the blocking block and meshed with the gear.

Optionally, the sealing assembly further includes a roller installed on the installation seat, the rack comprises a rolling groove, and the roller is rotatably installed on in the rolling groove.

Optionally, the outer cylinder includes: a cylinder cover, an upper cylinder body provided with the grain storage space, a lower cylinder body provided with the installation space, a partition plate installed in the grain storage space. The partition plate divides the grain storage space into an upper layer space and a lower layer space, and the partition plate is provided with a first through hole that communicates with the upper layer space and the lower layer space; the upper cylinder body is installed on the lower cylinder body, the lower cylinder body is provided with a second through hole that communicates with the installation space, and the grain discharging hose is plugged into the second through hole, and the inlet of the grain discharging hose communicates with the lower layer space; and an annular clamping groove is provided at an opening of the upper cylinder body, the cylinder cover is provided with an annular clamping part, and the cylinder cover is covered on the upper cylinder body by clamping the annular clamping part in the annular clamping groove.

Optionally, the cylinder cover comprises a counterweight provided thereon.

Optionally, the grain delivery assembly include a grain delivery driving part, a connecting shaft, a stirring fan and a toggling fan, and the toggling fan is provided with flexible grain delivery parts with a ring-shaped interval distribution, grain distribution slots are formed between two adjacent flexible grain delivery parts; and the grain delivery driving part is installed in the lower layer space, an output end of the grain delivery driving part is connected to the connecting shaft, the stirring fan and the toggling fan are both sleeved on the connecting shaft, the stirring fan is located in the upper layer space, and the toggling fan is located in the lower layer space.

Optionally, the vacuum feeder further includes a first broom and a second broom installed on the partition plate, the first broom and the second broom are respectively located on two opposite sides of the first through hole, and are both located in the lower layer space.

Optionally, the outer cylinder is further provided with an air passage communicating with the grain storage space, the vacuuming part is installed in the installation space, and the vacuuming part communicates with the air passage.

Optionally, the vacuuming part includes a vacuum pump, a three-way pipe and an air pressure valve all installed in the installation space, and the three-way pipe is provided with a first nozzle, a second nozzle and a third nozzle communicated with each other, a suction port of the vacuum pump communicates with the first nozzle, the second nozzle communicates with a detection port of the air pressure valve, and the third nozzle communicates with the air passage.

Optionally, the outer cylinder further includes a base, and the vacuum feeder further includes a feeding basin and an electronic scale, the electronic scale being installed on the base, and the feeding basin is installed on the electronic scale and used to receive the grain discharged by the grain discharging hose.

In the present application, when receiving a vacuuming instruction, the sealing driving part drives the blocking block and the sealing inclined plate to move toward the grain discharging hose until the blocking block squeezes and seals the middle part of the grain discharging hose (that is, make the inner wall surfaces on both sides of the grain discharging hose being attached to each other), and after the sealing inclined plate blocks the outlet of the grain discharging hose, the vacuuming part then extract the grain storage space into a vacuum state. In the present application, when the grain storage space is in a vacuum state, the grain discharging hose is sealed by the blocking block and the sealing inclined plate, thereby ensuring the tightness of the grain storage space, avoiding the interference of bacteria in the air on the food in the grain storage space, ensuring the safety of the food and prolonging the storage time of the food. In addition, the sealing inclined plate seals the outlet of the grain discharging hose, thereby avoiding accidents that bacteria and the like enter into the grain discharging hose and contaminate the grain discharging hose.

### BRIEF DESCRIPTION OF THE DRAWINGS

The present application is further described below in conjunction with accompanying drawing and embodiment.

FIG. 1 is a schematic structural view of a vacuum feeder provided by an embodiment of the present application.

FIG. 2 is a sectional view of a vacuum feeder provided by an embodiment of the present application.

FIG. 3 is a schematic structural view of a sealing assembly of a vacuum feeder provided by an embodiment of the present application.

FIG. 4 is a schematic structural view of an upper cylinder body, a cylinder cover and a grain discharging hose of a vacuum feeder provided by an embodiment of the present application.

FIG. 5 is a schematic structural view of a partition plate and parts thereof of a vacuum feeder provided by an embodiment of the present application.

FIG. 6 is a schematic structural view of a grain delivery assembly of a vacuum feeder provided by an embodiment of the present application.

The reference signs in the disclosure are as follows:
1. Vacuuming part; 2. Grain discharging hose; 3. Sealing assembly; 31. Sealing driving part; 311. Installation seat; 312. Rotating motor; 313. Gear; 314. Rack; 3141. Rolling groove; 32. Blocking block; 33. Sealing inclined plate; 34. Roller; 4. Grain delivery assembly; 41. Grain delivery driving part; 42. Stirring fan; 43. Toggling fan; 431. Flexible grain delivery part; 432. Grain distribution slot; 44. First broom; 45. Second broom; 46. Connecting shaft; 5. Outer cylinder; 51. Grain storage space; 511. Upper layer space; 512. Lower layer space; 52. Installation space; 53. Cylinder cover; 531. Counterweight; 532. Annular clamping part; 54. Upper cylinder body; 541. Annular clamping groove; 55. Lower cylinder body; 56. Partition plate; 561. First through hole; 57. Base; 6. Feeding basin.

### DETAILED DESCRIPTION OF THE EMBODIMENTS

In order to make the technical problems, technical solutions and beneficial effects solved by the present application clearer, the present application will be further described in detail below in conjunction with the accompanying drawings and embodiments. It should be understood that the specific embodiments described here are only used to explain the present application, and are not intended to limit the present application.

It should be understood that the orientation or positional relationship indicated by the terms “upper”, “lower”, “left”, “right”, “front”, “rear”, “middle”, etc. are based on the orientation or position shown in the drawings. The relationship is only for the convenience of describing the present application and simplifying the description, but does not indicate or imply that the device or element referred to must have a specific orientation, be constructed and operated in a specific orientation, and thus should not be construed as a limitation of the present application.

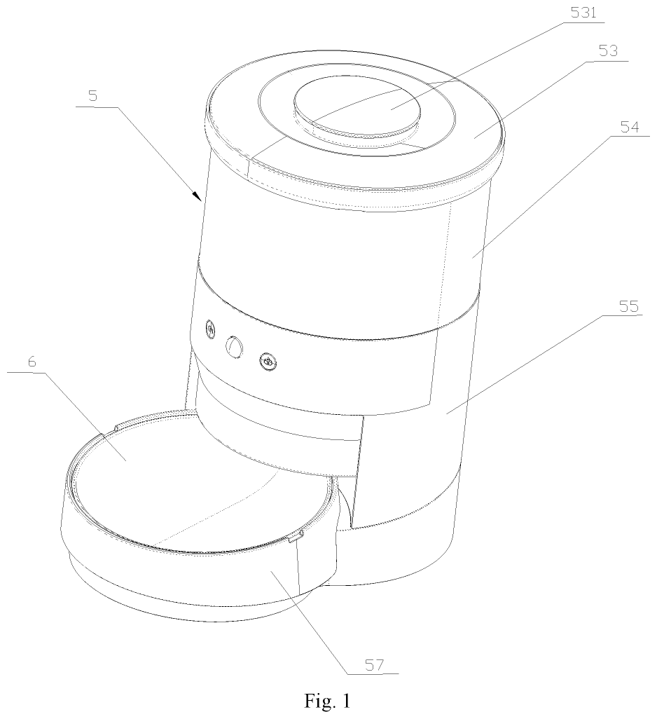

As shown in FIGS. 1 to 3, a vacuum feeder provided by an embodiment of the present application includes a vacuuming part 1, a grain discharging hose 2, a sealing assembly 3, a grain delivery assembly 4, and an outer cylinder 5 provided with a grain storage space 51 and an installation space 52. The vacuuming part 1 is used to extract the grain storage space 51 into a vacuum state. An inlet of the grain discharging hose 2 communicates with the grain storage space 51. The grain delivery assembly 4 is installed in the grain storage space 51, and is used to deliver the grain in the grain storage space 51 into the grain discharging hose 2. It can be understood that the vacuuming part 1 includes, but is not limited to, a vacuum pump, etc. The grain storage space 51 is located above the installation space 52. The grain discharging hose 2 may be made of silicone material.

The sealing assembly 3 includes a sealing driving part 31, a blocking block 32 and a sealing inclined plate 33 installed on the blocking block 32. An output end of the sealing driving part 31 is connected to the blocking block 32. The blocking block 32 is used to compress and seal the grain discharging hose 2. The sealing inclined plate 33 is used to block an outlet of the grain discharging hose 2. It can be understood that the sealing driving part 31 includes, but is not limited to, linear motors, pneumatic cylinders, hydraulic cylinders, gear and rack structures, and so on. The sealing inclined plate 33 is installed under the blocking block 32, and the surface of the sealing inclined plate 33 facing the grain discharging hose 2 is an inclined plane.

When receiving a vacuuming instruction, the sealing driving part 31 drives the blocking block 32 and the sealing inclined plate 33 to move toward the grain discharging hose 2 until the blocking block 32 squeezes and seals the middle part of the grain discharging hose 2 (that is, make the inner wall surfaces on both sides of the grain discharging hose 2 being attached to each other), and after the sealing inclined plate 33 blocks the outlet of the grain discharging hose 2, the vacuuming part 1 then extract the grain storage space 51 into a vacuum state. In the present application, when the grain storage space 51 is in a vacuum state, the grain discharging hose 2 is sealed by the blocking block 32 and the sealing inclined plate 33, thereby ensuring the tightness of the grain storage space 51, avoiding the interference of bacteria in the air on the food in the grain storage space 51, ensuring the safety of the food and prolonging the storage time of the food. In addition, the sealing inclined plate 33 seals the outlet of the grain discharging hose 2, thereby avoiding accidents that bacteria and the like enter into the grain discharging hose 2 and contaminate the grain discharging hose 2.

When receiving a feeding command, the sealing driving part 31 drives the blocking block 32 and the sealing inclined plate 33 away from the grain discharging hose 2, and the grain discharging hose 2 will automatically return to the conduction state so that the grain in the grain storage space 51 is discharged through the grain discharging hose 2 driven by the grain delivery assembly 4, and then the vacuum feeder completes the feeding work for pets. In the present application, the vacuum feeder has simple structure, low manufacturing cost and convenient use.

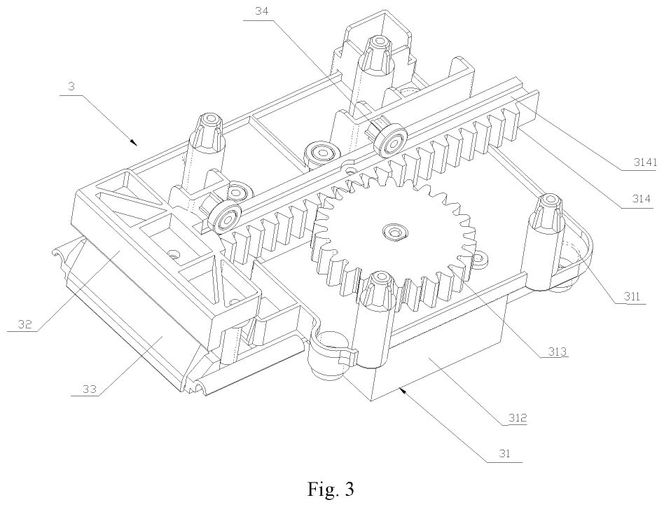

In an embodiment, as shown in FIG. 3, the sealing driving part 31 includes an installation seat 311, a rotating motor 312, a gear 313 and a rack 314. The installation seat 311 is installed in the installation space 52. The rotating motor 312 is installed on the installation seat 311. The gear 313 is sleeved on an output shaft of the rotating motor 312. The rack 314 is connected to the blocking block 32, and the rack 314 is meshed with the gear 313. It can be understood that the rotating motor 312 is installed at the bottom of the installation seat 311, and the gear 313 and the rack 314 are both installed at the top of the installation seat 311.

Specifically, the rotating motor 312 drives the gear 313 to rotate, the gear 313 drives the rack 314 to move, and the rack 314 drives the blocking block 32 and the sealing inclined plate 33 to move toward or away from the grain hose delivery 2. In the embodiment, the sealing driving part 31 has a simple structure, low manufacturing cost, and occupies a small space.

In an embodiment, as shown in FIG. 3, the sealing assembly 3 further includes a roller 34 installed on the installation seat 311, and a rolling groove 3141 provided on the rack 314. The roller 34 is rotatably installed in the rolling groove 3141. It can be understood that during the movement of the rack 314, the roller rotates in the rolling groove 3141, so that the cooperation between the roller 34 and the rolling groove 3141 can serve as guide for the movement of the rack 314, thereby ensuring the stability of the movement of the rack 314.

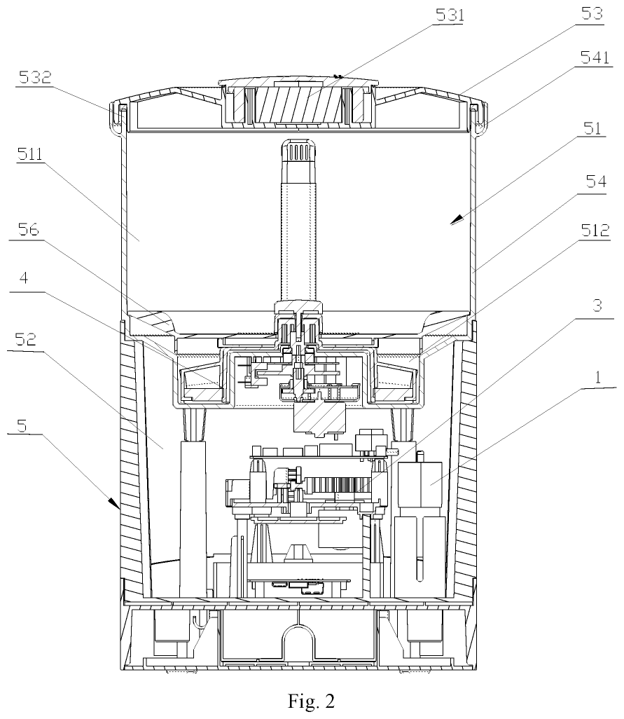

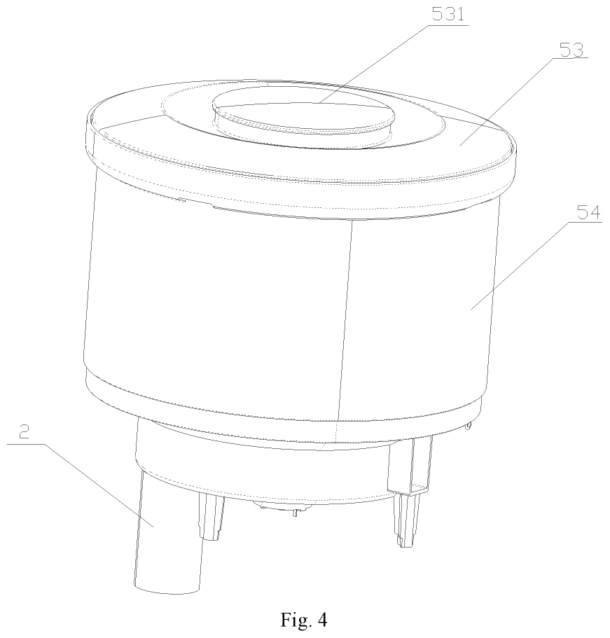

In an embodiment, as shown in FIG. 1, FIG. 2 and FIG. 4, the outer cylinder 5 includes a cylinder cover 53, an upper cylinder body 54 provided with the grain storage space 51, and a lower cylinder body 55 provided with the installation space 52, and a partition plate 56 installed in the grain storage space 51. The partition plate 56 divides the grain storage space 51 into an upper layer space 511 and a lower layer space 512, and the partition plate 56 is provided with a first through hole 561 that communicates with the upper layer space 511 and the lower layer space 512. The upper cylinder body 54 is installed on the lower cylinder body 55. The lower cylinder body 55 is provided with a second through hole (not shown in the figure) that communicates with the installation space 52. The grain discharging hose 2 is plugged into the second through hole, and the inlet of the grain discharging hose communicates with the lower layer space 512. It can be understood that the upper end of the lower cylinder body 55 is an opening structure, and the upper cylinder body 54 is sealed and installed on the upper end of the lower cylinder body 55.

Specifically, the grain delivery assembly 4 stirs the grain in the upper layer space 511, and the grain in the upper layer space 511 falls into the lower layer space 512 through the first through hole 561. The grain in the lower layer space 512 enters into the grain discharging hose 2 through the second through hole.

An annular clamping groove 541 is provided with at the opening of the upper cylinder body 54, and the cylinder cover 53 is provided with an annular clamping part 532. The cylinder cover 53 is covered on the upper cylinder body 54 by clamping the annular clamping part 532 in the annular clamping groove 541. It can be understood that the annular clamping groove 541 is disposed on the top of the upper cylinder body 54, and the cylinder cover 53 is covered on the top of the upper cylinder body 54. In the embodiment, the outer cylinder 5 has a simple structure and low manufacturing cost.

In an embodiment, as shown in FIG. 2, a counterweight 531 is further provided on the cylinder cover 53. It can be understood that the counterweight 531 is installed at the central part of the cylinder cover 53. Specifically, when the vacuuming part 1 extracts the upper layer space 511 into a vacuum state, the upper layer space 511 in the vacuum state has a downward suction force on the cylinder cover 53, and at the same time, the counterweight 531 has a downward pressure on the cylinder cover 53, thereby ensuring the sealing performance of the cylinder cover 53 on the upper cylinder body 54.

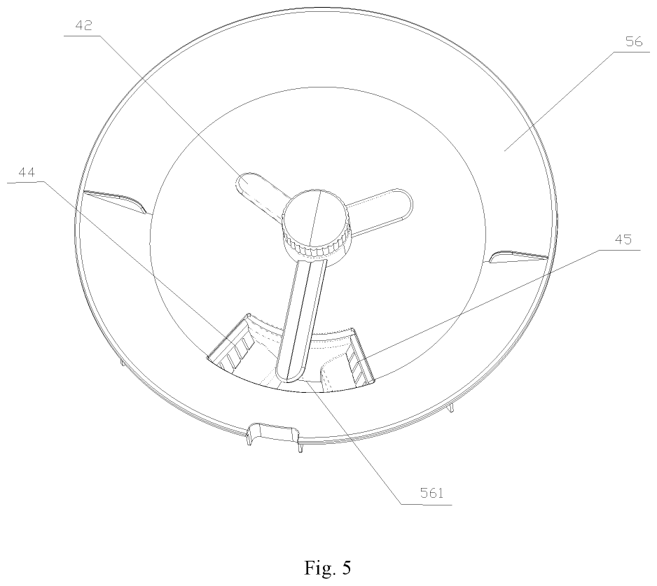

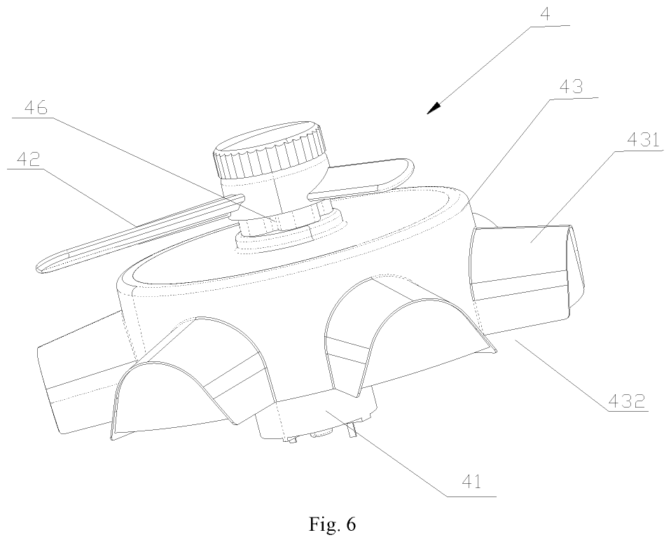

In an embodiment, as shown in FIG. 5 and FIG. 6, the grain delivery assembly 4 includes a grain delivery driving part 41, a connecting shaft 46, a stirring fan 42 and a toggling fan 43. The toggling fan 43 is provided with flexible grain delivery parts 431 with a ring-shaped interval distribution, and grain distribution slots 432 are formed between two adjacent flexible grain delivery parts 431. It can be understood that the toggling fan 43 may be made of silica gel material. The number of the flexible grain delivery parts 431 may be designed according to actual needs, for example, the flexible grain delivery part 431 is provided with 3, 4, etc.

The grain delivery driving part 41 is installed in the lower layer space 512, and an output end of the grain delivery driving part 41 is connected to the connecting shaft 46. The stirring fan 42 and the toggling fan 43 are both sleeved on the connecting shaft 46, the stirring fan 42 is located in the upper layer space 511, and the toggling fan 43 is located in the lower layer space 512. It can be understood that the partition plate 56 is provided with a through hole, and the connecting shaft 46 is connected to the stirring fan 42 after passing through the through hole. The bottom of the stirring fan 42 abuts the top surface of the partition plate 56. The toggling fan 43 abuts the lower bottom surface of the upper layer space 511.

Specifically, the stirring fan 42 and the toggling fan 43 are driven to rotate by the grain delivery driving part 41 through the connecting shaft 46. The stirring fan 42 stirs the grain in the upper layer space 511, so that the grain in the upper layer space 511 falls into the lower layer space 512 through the first through hole 561. The toggling fan 43 drives the grain in the lower layer space 512 to rotate. When the grain distribution slot 432 containing the grain is rotated to the top of the second through hole, the grain in the grain distribution slot 432 will drop into the grain discharging hose. In the embodiment, the grain delivery assembly 4 has a simple structure and low manufacturing cost.

In addition, when grains are jammed between the flexible grain delivery part 431 and the partition plate 56, the grains will drive the flexible grain delivery part 431 to deform. The deformed flexible grain delivery part 431 is easy to make the jammed grains fall, thereby reducing the accident of grain jam in the vacuum feeder.

In an embodiment, as shown in FIG. 5, the vacuum feeder also includes a first broom 44 and a second broom 45 installed on the partition plate 56. The first broom 44 and the second broom 45 are respectively located on two opposite sides of the first through hole 561 and are both located in the lower layer space 512. It can be understood that the first broom 44 and the second broom 45 are installed on the left and right sides of the first through hole 561. The first broom 44 and the second broom 45 may act to allow the grain in the upper layer space 511 to fall into the grain distribution slot 432, and the first broom 44 and the second broom 45 further reduce the accident of grain jam in the vacuum feeder.

In an embodiment, as shown in FIG. 2, the outer cylinder 5 is also provided with an air passage (not shown in the figure) communicating with the grain storage space 51. The vacuuming part 1 is installed in the installation space 52, and the vacuuming part 1 communicates with the air passage. It can be understood that the air passage is arranged on the inner wall of the grain storage space 51. In the embodiment, the vacuuming part 1 is installed in the installation space 52, thereby increasing the volume of the grain storage space 51, preventing the grain from interfering with the vacuuming part 1, and prolonging the service life of the vacuum feeder.

In an embodiment, the vacuuming part 1 includes a vacuum pump (not shown in the figure), a three-way pipe (not shown in the figure) and an air pressure valve (not shown in the figure) all installed in the installation space 52. The three-way pipe is provided with a first nozzle, a second nozzle and a third nozzle communicated to each other. A suction port of the vacuum pump communicates with the first nozzle, the second nozzle communicates with a detection port of the air pressure valve, and the third nozzle communicates with the air passage. It can be understood that an air outlet of the vacuum pump communicates with the external environment through a pipeline. Since the grain storage space 51, the air passage and the third nozzle communicate with the three-way pipe, the air pressure valve may detect the pressure value in the grain storage space 51 in real time through the third nozzle. The air pressure valve is installed in the installation space 52, and it is in atmospheric pressure, so as to facilitate the detection of the pressure value in the grain storage space 51.

When it is detected by the air pressure valve that the pressure value of the grain storage space 51 is lower than a first preset negative pressure value, the vacuum pump is controlled to stop vacuuming the grain storage space 51. It can be understood that the first preset negative pressure value may be set according to actual needs. For example, the first preset negative pressure value is −20 pa, −25 pa, −15 pa, and so on. In a specific embodiment, the first preset pressure value is −20 pa. When the air pressure valve detects that the pressure value in the grain storage space 51 is less than −20 pa (for example, the pressure in the grain storage space 51 is −21 pa), the vacuum pump is controlled to stop vacuuming the grain storage space 51, thereby avoiding the accident of destroying the vacuum feeder due to excessive negative pressure in the grain storage space 51, and ensuring the safety of the vacuum feeder.

Further, when it is detected by the air pressure valve that the pressure value in the grain storage space 51 is greater than a second preset negative pressure value, the vacuum pump is controlled to vacuumize the grain storage space 51 until the pressure value in the grain storage space 51 is less than the first preset negative pressure value; wherein, the second preset negative pressure value is greater than the first preset negative pressure value. For example, the second preset negative pressure value is −10 pa, and the first preset negative pressure value is −20 pa. It can be understood that when the grain discharging hose 2 is closed, the outer cylinder 5 will inevitably leak. When the air pressure valve detects that the pressure in the grain storage space 51 (e.g., −9 pa) is greater than the second preset pressure value, the vacuum pump is automatically controlled to vacuumize the grain storage space 51 until the air pressure valve detects that the pressure value in the grain storage space 51 is less than the first preset negative pressure value. Therefore, the pressure value in the grain storage space 51 is always maintained within an appropriate negative pressure range (that is, the pressure value in the grain storage space 51 is greater than the first preset negative pressure value and less than the second preset negative pressure value), further ensuring the safety of the food in the grain storage space 51.

In an embodiment, as shown in FIG. 1, a base 57 is also provided on the outer cylinder 5. The vacuum feeder also includes a feeding basin 6 and an electronic scale (not shown in the figure) installed on the base 57. The feeding basin 6 is installed on the electronic scale, and is used to receive the grain discharged by the grain discharging hose 2. It can be understood that the feeding basin 6 is installed below an outlet of the grain discharging hose 2, and the grains discharged by the grain discharging hose will drop into the feeding basin 6. The electronic scale may detect the weight of the grain in the feeding basin 6 in real time, thereby the sealing assembly 3 being controlled to block the grain discharging hose 2 in time, so that the user may control the feeding amount of the vacuum feeder, further improving the user experience of the vacuum feeder.

The above is only the embodiment of the vacuum feeder of the present application, and is not intended to limit the present application. Any modifications, equivalent replacements and improvements made within the spirit and principles of the present application should be included within the scope of protection of the present application.

What is claimed is:

1. A vacuum feeder, comprising:
a vacuuming part;
a grain discharging hose;
a sealing assembly;
a grain delivery assembly; and
an outer cylinder provided with a grain storage space and an installation space;
wherein the vacuuming part is used to extract the grain storage space into a vacuum state;
an inlet of the grain discharging hose communicates with the grain storage space;
the grain delivery assembly is installed in the grain storage space, and is used to deliver grain in the grain storage space into the grain discharging hose; and
the sealing assembly comprises:
a sealing driving part;
a blocking block;
a sealing inclined plate installed on the blocking block; and
wherein an output end of the sealing driving part is connected to the blocking block, and the blocking block is used to compress and seal the grain discharging hose, and the sealing inclined plate is used to block an outlet of the grain discharging hose.

2. The vacuum feeder according to claim 1, wherein the sealing driving part comprises an installation seat, a rotating motor, a gear and a rack, the installation seat is installed in the installation space, the rotating motor is installed on the installation seat, the gear is sleeved on an output shaft of the rotating motor, and the rack is connected to the blocking block and meshed with the gear.

3. The vacuum feeder according to claim 2, wherein the sealing assembly further comprises a roller installed on the installation seat, the rack comprises a rolling groove, and the roller is rotatably installed on in the rolling groove.

4. The vacuum feeder according to claim 1, wherein the outer cylinder comprises:
a cylinder cover;
an upper cylinder body provided with the grain storage space;
a lower cylinder body provided with the installation space; and
a partition plate installed in the grain storage space;
wherein the partition plate divides the grain storage space into an upper layer space and a lower layer space, and the partition plate is provided with a first through hole that communicates with the upper layer space and the lower layer space;
the upper cylinder body is installed on the lower cylinder body, the lower cylinder body is provided with a second through hole that communicates with the installation space, and the grain discharging hose is plugged into the second through hole, and the inlet of the grain discharging hose communicates with the lower layer space; and
an annular clamping groove is provided at an opening of the upper cylinder body, the cylinder cover is provided with an annular clamping part, and the cylinder cover is covered on the upper cylinder body by clamping the annular clamping part in the annular clamping groove.

5. The vacuum feeder according to claim 4, wherein the cylinder cover comprises a counterweight provided thereon.

6. The vacuum feeder according to claim 4, wherein the grain delivery assembly comprise a grain delivery driving part, a connecting shaft, a stirring fan and a toggling fan, and the toggling fan is provided with flexible grain delivery parts with a ring-shaped interval distribution, grain distribution slots are formed between two adjacent flexible grain delivery parts; and
the grain delivery driving part is installed in the lower layer space, an output end of the grain delivery driving part is connected to the connecting shaft, the stirring fan and the toggling fan are both sleeved on the connecting shaft, the stirring fan is located in the upper layer space, and the toggling fan is located in the lower layer space.

7. The vacuum feeder according to claim 4, wherein the vacuum feeder further comprises a first broom and a second broom installed on the partition plate, the first broom and the second broom are respectively located on two opposite sides of the first through hole, and are both located in the lower layer space.

8. The vacuum feeder according to claim 1, wherein the outer cylinder is further provided with an air passage communicating with the grain storage space, the vacuuming part is installed in the installation space, and the vacuuming part communicates with the air passage.

9. The vacuum feeder according to claim 8, wherein the vacuuming part comprises a vacuum pump, a three-way pipe and an air pressure valve all installed in the installation space, and the three-way pipe is provided with a first nozzle, a second nozzle and a third nozzle communicated with each other, a suction port of the vacuum pump communicates with the first nozzle, the second nozzle communicates with a detection port of the air pressure valve, and the third nozzle communicates with the air passage.

10. The vacuum feeder according to claim 1, wherein the outer cylinder further comprises a base, and the vacuum feeder further comprises a feeding basin and an electronic scale, the electronic scale is installed on the base, and the feeding basin is installed on the electronic scale and used to receive the grain discharged by the grain discharging hose.
